(19) United States
(12) Patent Application Publication
(10) Pub. No.: US 2015/0047661 A1
(43) Pub. Date: Feb. 19, 2015

(54) VAPOR DELIVERY DEVICE

(71) Applicants: Johnathan Seamus Blackley, South Pasadena, CA (US); André LaMothe, Austin, TX (US)

(72) Inventors: Johnathan Seamus Blackley, South Pasadena, CA (US); André LaMothe, Austin, TX (US)

(21) Appl. No.: 14/345,072

(22) PCT Filed: Sep. 13, 2012
(86) PCT No.: PCT/US12/55257

§ 371 Date: Nov. 5, 2014

Related U.S. Application Data
(60) Provisional application No. 61/534,859, filed on Sep. 14, 2011.

(51) Int. Cl. A24F 47/00; H05B 3/12

(52) U.S. Cl. CPC A24F 47/008; H05B 3/12
USPC 131/329; 392/387

(57) ABSTRACT

A vapor delivery device and method for controlling the vaporization of a fluid by a vapor delivery device. An exemplary vapor delivery device comprises a housing, a liquid tank disposed within the housing and adapted to hold a fluid, a heating element disposed within the housing and being operable to vaporize at least a portion of the fluid, a power source disposed with the housing and electronically coupled to the power source and the heating element, an electronics portion adapted to control heating element and the power source, and an outlet extending from the liquid tank to an opening in the housing.

### RELATED CASE DATA

This application is the National Stage of International Patent Application No. PCT/US2012/055257, filed Sep. 13, 2012, which claims priority to U.S. Provisional Application No. 61/534,859, filed Sep. 14, 2011, all of which are hereby incorporated by reference in their entirety.

### BACKGROUND

It is well known to deliver various substances into the human body as a vapor that is inhaled. For example, “electronic cigarettes”, in which nicotine is delivered into the body, are well known. Also, other substances such as various drugs can be delivered as a vapor.

Known electronic cigarettes generally include a power supply, such as a battery, a tank holding nicotine substance in solution, and a heating element to vaporize the solution. The vapor can then be inhaled by the user. Electronic cigarettes are often designed to look roughly like a conventional cigarette, which consists essentially of tobacco and other substances rolled in paper with filter. However, due the components above, and other electronics, electronic cigarettes are often larger than conventional cigarettes. Also, electronic cigarettes are rigid and lack the tactile feel of conventional cigarettes. Finally, since electronic cigarettes include a battery or other power source of relatively high power, electronic cigarettes can be hazardous to the environment when disposed of Further, electronic cigarettes lack the natural look and feel of conventional cigarettes which is often considered part of the desirable experience by users.

Various other devices which deliver metered doses of drugs, in a vapor form, are well known. However, such devices are often complex and cumbersome for the user/patient. For example, such device may require the patient may to wear a mask or may require that tubes be secured to the patient's mouth or nose.

### BRIEF DESCRIPTION OF THE DRAWINGS

FIG. 1 is a physical schematic representation of a side cross-sectional view of an electronic cigarette according to the disclosed embodiment.

FIG. 2 is an electrical schematic diagram of a power boost circuit according to the disclosed embodiment.

FIG. 3 is an overall electrical schematic diagram according to the disclosed embodiment.

FIG. 4 is a physical schematic of the lighting section according to the disclosed embodiment.

FIGS. 5A-5B illustrate a diffuser of the lighting section according to the disclosed embodiment.

FIG. 6 illustrates an exemplary filter according to the disclosed embodiment.

### DETAILED DESCRIPTION

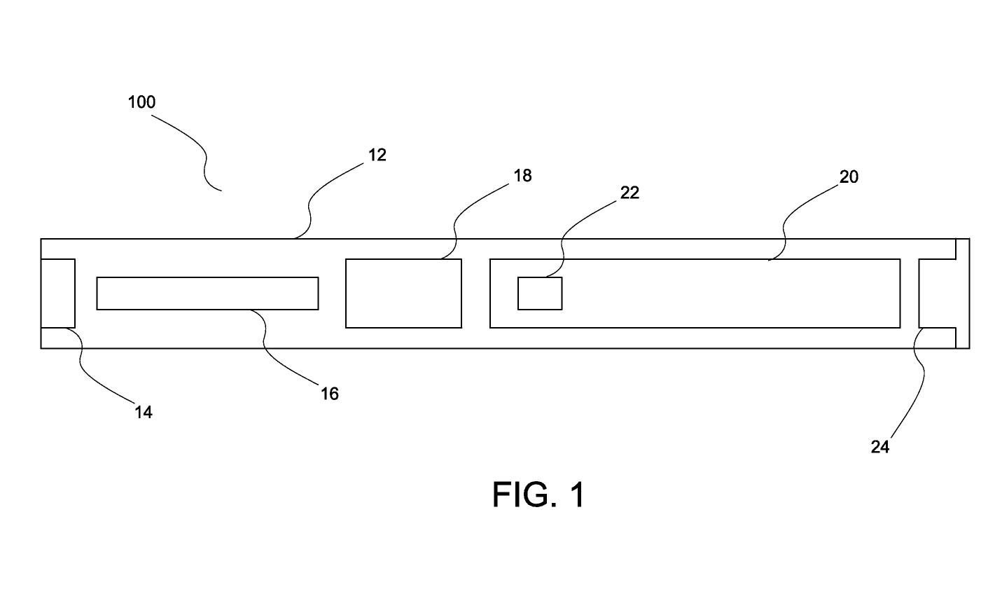

The disclosed embodiment relates to an electronic cigarette 100 as illustrated in FIG. 1. Cigarette 100 has housing 12 which supports and/or encloses the remaining elements described below. A passage is defined through at least a portion of housing 12 in a known manner to allow a user to place their mouth at the proximal end of cigarette 100 and inhale vapor from cigarette 100 as described below. As an example, portions of the passage can be defined through an annulus defined between housing 12 and other components described below.

Lighting section 14 is disposed at a distal end of housing 12 and can be entirely disposed within housing 12, partially disposed within housing 12 or fully extending form the distal end of housing 12. Lighting section 14 serves to simulate the burning ember of a cigarette as described in greater detail below. Battery 16, as a power source, is disposed within housing 12. Also disposed within housing 12 are electronics section 18, liquid tank 20, and heating element 22. As FIG. 1 is merely a schematic representation, the requisite electrical connections are not shown. However such connections are well known and within the knowledge of one of ordinary skill in the art based on the disclosure herein.

Battery 16 is electrically coupled to lighting section 14, electronics section 18, and heating element 22. Electronics section 18 can include a logic processor, power electronics and one or more sensors, as will be described in greater detail below. When a user inhales through the distal end of cigarette 100, heating element 22 heats liquid in liquid tank 20 to a vapor and the vapor is inhaled by the user through, according to the disclosed embodiment, filter 24. The liquid can include nicotine and other components to facilitate vaporization. Of course, the liquid can include any substance that is to be inhaled.

As noted above, heating element 22 is powered by battery 16 to vaporize a liquid containing nicotine and other substances, so that a user can inhale the material in vapor form. For example heating element 22 can be made at least partially of a nichrome alloy. Heating element 22 can also be formed of any alloy that is capable of providing the required heat, which may include, for example, Ni200, Ni270, AL 294, CuNi 294, Alloy 120, 160, 180, and the like.

However, heating element 22 requires a relatively large current, 0.8-2 Amps, for example. Thus, Li-Ion batteries are typically employed. However, such batteries require recharging, and are dangerous if they are overheated and can even explode. Alkaline battery chemistry yields batteries that are safer and better for the environment. Alkaline batteries produce far less energy per unit mass, have a large internal resistance, and have a much lower output voltage (1.5V as compared to 3.7-4.2V for Li-Ion). For these reasons standard 1.5V alkaline batteries have not previously been sufficient in the form factor required for an electronic cigarette. In the alternative, lithium iron phosphate (LiFePo₄) batteries can be used. These batteries are almost as powerful as Li-Ion, but use a much safer technology, don't explode, and are not considered hazardous. LiFePo₄ batteries can be used either with or without the boost conversion technology discussed below. Other battery types may also be suitable for use with the vapor delivery device of the disclosed embodiment including, for example, Aluminum, Silver, Air, etc.

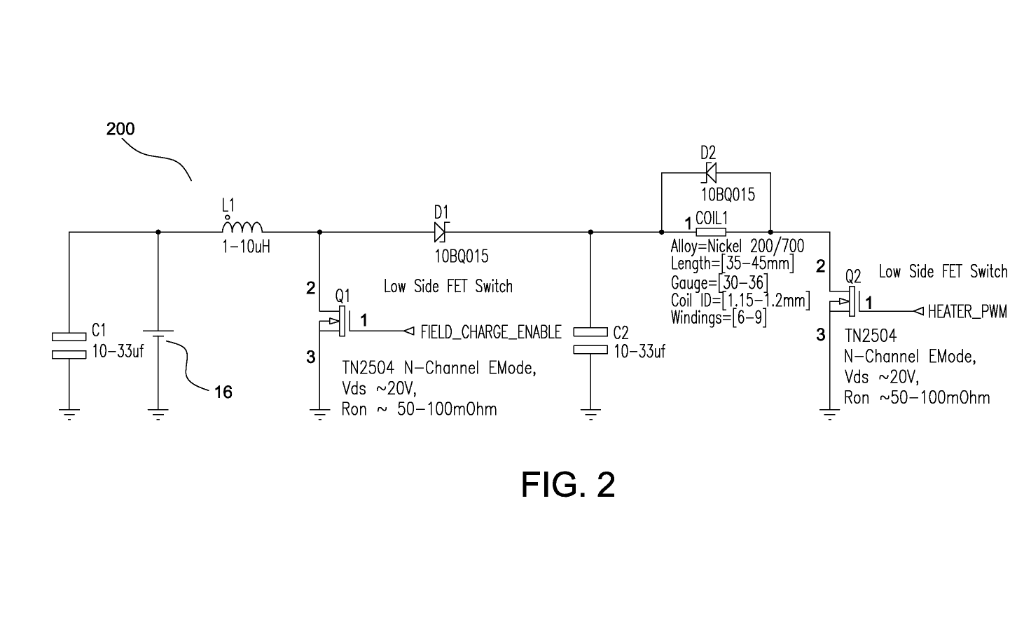

Regardless of which battery type is used, the disclosed embodiment may utilize a “boost converter” topology, as illustrated in FIG. 2, to extract energy from the battery “off line” and store it in a magnetic field, then to dump that energy into a capacitor in form of charge (the resulting electric field is where the actual energy is) and then finally to dump that charge thru the heating coil and then to repeat this process rapidly. Boost convertor circuit 200 is part of electronics section 18. Battery 16 supplies a current to inductor L1 via the transistor switch Q1. When Q1 is closed by means of external control via the signal path FIELD_CHARGE_ENABLE, then a current will begin to flow from BAT1 thru L1 down thru Q1 to ground. This current is modeled by the relationship between inductor, current, voltage, and time:

V=L*(di/dt)

During this phase the circuitry from diode D1 to the right in FIG. 2 is functionally disconnected from battery 16 since the path of least resistance is thru switch Q1. Moreover, battery 16 will attempt to supply as much current as possible to inductor L1 (which will seem like a dead short), thus as the battery supplies current to inductor L1, this induces a magnetic field, this magnetic field stores energy and generates a voltage on inductor L1 counter to that of the direction of current flow. In this “charging stage” of operation, battery 16 is dumping as much current as possible based on its intrinsic resistance, but the loss of voltage is irrelevant at this point since we battery 16 is serving as a “current source”. Therefore, energy is harvested from battery 16, but the voltage drop that is occurring under the high load of a near short circuit (inductors have very little resistance on the order of milli-ohms) does not matter.

At some point (controlled by the signal FIELD_CHARGE_ENABLE) transistor switch Q1 is disabled, this creates a high impedance path from inductor L1 to ground thru Q1, thus the magnetic field of inductor L1 has stored energy. In view of the inherent property that current through an inductor can't change instantaneously, inductor L1 will tend to maintain the current constant at whatever value of current was at the end of the charging phase. To do this, inductor L1 will generate whatever voltage is needed to maintain this physical constant of the current. As it does so, current flows thru diode D1 (which is now the lowest path of resistance) into storage capacitor C2. Capacitor C1 draws power from battery 16 during each pulse of this “harvesting phases”.

During the harvesting phase, when the current from inductor L1 is flowing into capacitor C2, charge builds up on capacitor C2 and the current is converted into a high voltage. While this is going on, transistor switch Q2 is OFF, thus there is no path for the current from capacitor L1, other than into capacitor C2. At some point, not necessarily synchronous to the signal on transistor switch Q1 controlling it, the circuit then enables transistor switch Q2 via the control signal HEATER_PWM and this allows the charge stored on capacitor C1 to flow into the heating element 22 and to ground to cause heating element 22 to dissipate the voltage as heat.

A logic processor of electronics section 18 controls the two control signals FIELD_CHARGE_ENABLE and HEATER_PWM to thereby use battery 16 as a current source to generate a magnetic field in inductor L1, this magnetic field is then collapsed and during this collapse, a voltage is generated which creates a current that flows thru diode D1 into storage capacitor C2 converting the energy into an electrostatic field. One or more cycles into the process, switch Q2 is closed by the logic controller allowing the stored charge in capacitor C2 to flow thru heating element 22. The timing and other logic variables can be adjusted to optimize power as is readily apparent to one of skill in the art based on this disclosure. The circuit can operate in the KHz to MHz range depending on components and desired performance. The logic processor can be a PIC™ processor manufactured by Microchip™, for example. The logic processor can be used to control all aspects of the device.

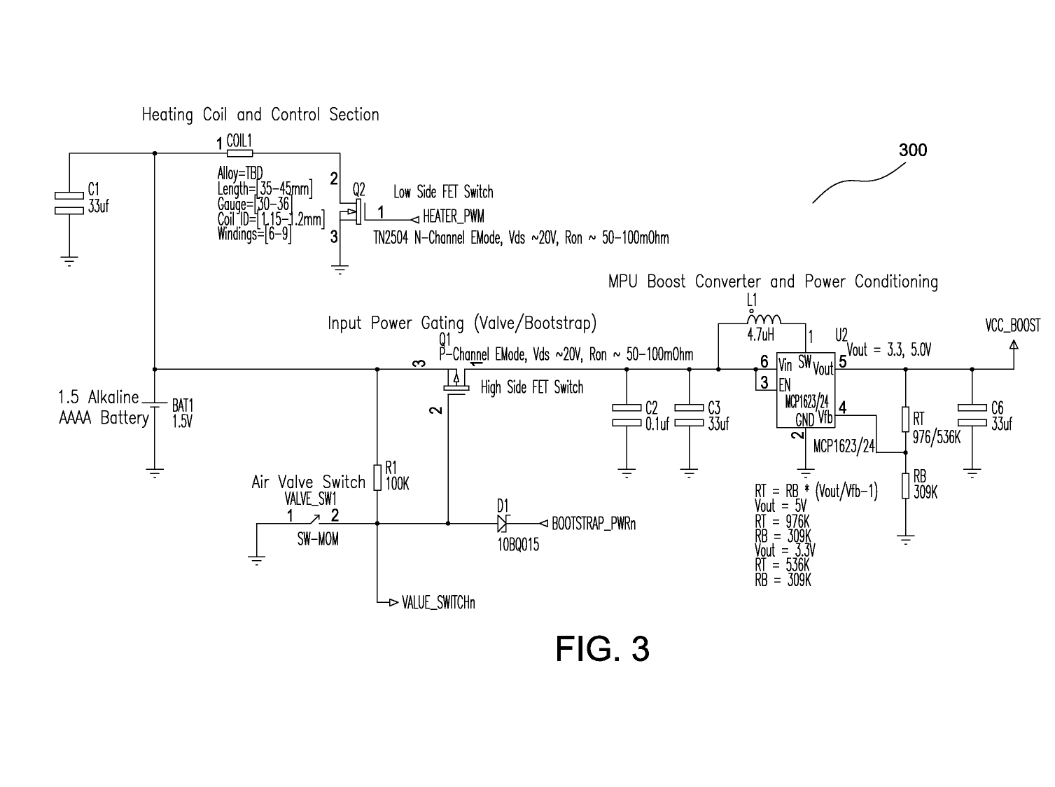

FIG. 3 illustrates the overall electrical system 300 according to the disclosed embodiment. In order to achieve zero power drain when the device is not in packaging or not in use, the disclosed embodiment preferably uses a “bootstrap” power arrangement. When the device is off, there is no power being drained from battery 16. On the other hand, once the unit has been powered up for use, the unit then bootstraps its own power on for a certain amount of time (e.g., 1, 5, or 10 minutes) in anticipation of continuous use. For example, when the device is opened for the first time, removed from the packaging, and the user takes a “drag”, the device is powered up by air valve switch SW1 due to vacuum from the users inhalation. In response, the device then goes into an “in use” mode and even when the valve switch SW1 is disengaged the device keeps itself powered by asserting the signal BOOTSTRAP_PWRn through diode D1. This way the device can retain “state” and keep memory active. Both of these inputs gate the input power acting as an “OR” gate which drives the power FET Q1 which allows current to flow into the processor. If the user waits long enough between “drags” or continued use, then the software decides that for all intent purposes the unit is “off” and then de-asserts the signal BOOTSTRAP_PWRn shutting the system down completely and drawing zero power.

Therefore, the bootstrap circuit allows the device to go from a completely off state to an on state, and stay on during use, and then remain on for some programmable period until it can be assumed that the user is done using the device and the system can shut down and lose its current state and volatile memory until the next usage. Initially, the unit is booted up with the valve switch VALUE_SW1 being activated by the user dragging on the device, but once the system is powered up, it bootstraps itself by continuously asserting the other “OR'ed” signal BOOTSTRAP_PWRn until enough time has elapsed between actual user “drags” on the product and the system shuts down completely.

In addition, once the vapor delivery device of the disclosed embodiment is assembled, the battery, which is typically pre-charged, is not easily accessible. Since the power sources described herein, such as li-ion or other re-chargeable battery technologies, have a slow monthly discharge rate, for example, from 3-5%, the disclosed embodiment further provides for either a physical contact(s) at the tip or center of the housing 12 which can be used to make an electrical connection to the battery for recharging, or, in the alternative, a small coil which can be positioned within electrical system 300 to facilitate “inductive charging” via an electromagnetic field and/or non-contact charging. Both of these techniques can be used to “freshen” the battery before shipping to final distribution points or use after an extended period of time.

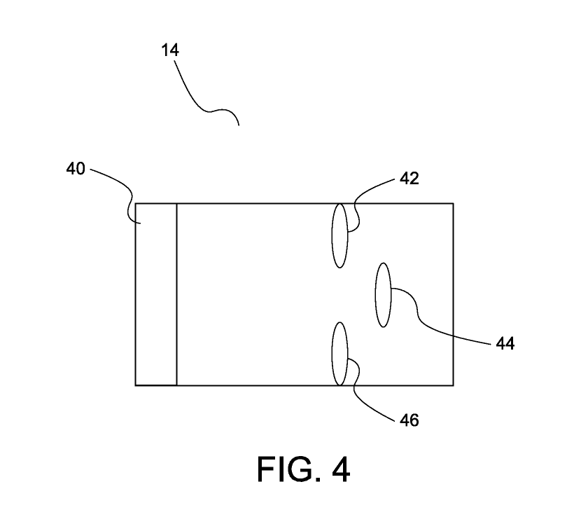

FIG. 4 illustrates lighting section 14 in greater detail. Lighting section 14 includes three light emitting elements (LEDs for example), light emitting element 42, light emitting element 44, and light emitting element 46. A signal line from the logic processor can be used to control each of the light emitting elements 42, 44, and 46 independently. For example, a single TX serial line OR a 2 line SPI/I2C bus along with IO expander can be used. Light emitting elements 42, 44, and 46 can each be of a different color, such as red, yellow, orange, white or other colors as needed to create the desired appearance as will become clear below. Various numbers and arrangements of light emitting elements can be used, such as a 3×3 or 4×4 array. Diffuser 40, such as a diffusing lens, is disposed at a distal end of lighting package 14 to diffuse the light emitted from light emitting elements 42, 44, and 46 to simulate the look of a burning ember.

Activation of the light emitting elements 42, 44, and 46 can be controlled by the logic processor to create a desired ember effect. Electronics section 18 can include various sensors, such as a pressure and temperature sensors in the passage and/or liquid tank 20. Control of light emitting elements 42, 44, and 46 can be based on the output of the sensors to simulate the look and feel of the ember on a conventional cigarette. For example, the “ember” can be brighter as a user inhales and can change based on the heat/pressure in the device in a manner that simulates a conventional cigarette.

In addition to lighting section 14, housing 12 may also include a charge indicator, for example, in a position relative to battery 16. The charge indicator can be in the form of a light ring that glows a particular color or a light bar under the exterior surface of the battery, so as not to be overt. The charge indicator can light up once the user starts using the product, and then indicate charge, so the user knows how much battery life he has. The charge indicator may use any suitable lighting effects and may be positioned anywhere on housing 12.

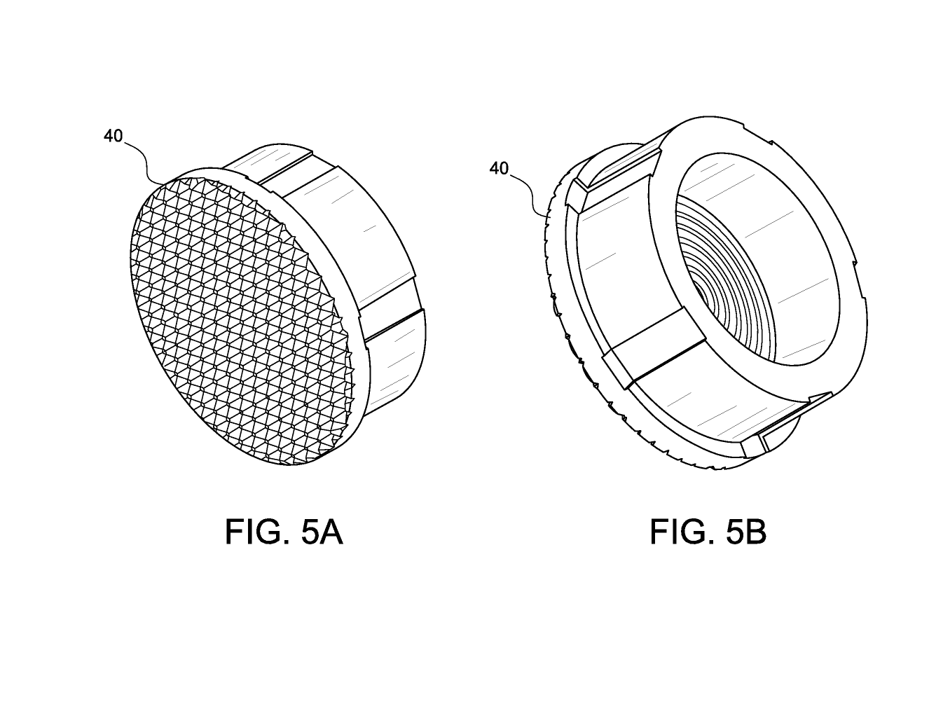

FIGS. 5A and 5B show an example of diffuser 40 in the form of a lens having pyramidal projections on a front surface and concentric ring structures on a back surface which faces light emitting elements 42, 44, and 45. However, diffuser 40 can take any form that diffuses the light to an intended degree and can include a lens with various structures on either side thereof.

The logic processor can use the various sensors to control operation of the device. For example, temperature sensors can be used to control temperature in liquid tank 20 to optimally vaporize the liquid. Heating element 22 can be controlled based on the temperature in liquid tank 20, ambient temperature, surface temperature indicating whether the device is being held by a user, or any combination of these variables and other variables such as pressure at different portions of the device.

A magnetic device, such as a rare earth magnet, can be placed in the passageway, near the proximal end for example, to capture any metallic particles resulting from ablation of heating element 22 or the like. This minimizes undesired tastes resulting from such materials.

The sensors and logic processor can also be used to capture, store, and transmit use analytics, such as information logging and statistical use analysis. For example, the amount of substance vaporized and delivered to the user can be logged. Also, operation of the device can be optimized to a specific user habits or type of user, such as long or short “drags”, frequency of drags, and the like. Optimization can be accomplished during use or can be integrated into the design and operation of subsequent devices. The data can be transmitted to a central server or the like through a wired or wireless connection to a user computer and the internet. Alternatively, the device can be returned to the manufacturer or a representative for downloading of data. The power source can be a lithium ion battery, an alkaline battery, a zinc oxide battery or any other appropriate power source.

Vaporization can be accomplished using a piezo electric device or other vaporization device in place of a heating element. Housing 12 can be rigid or can have softer more tactile elements incorporated thereon. For example, housing 12 could include a paper wrapping to provide the look and feel of a conventional cigarette. Generally speaking, housing 12 may be formed of any suitable material including, for example, plastic, paper, ceramics, steel, and the like.

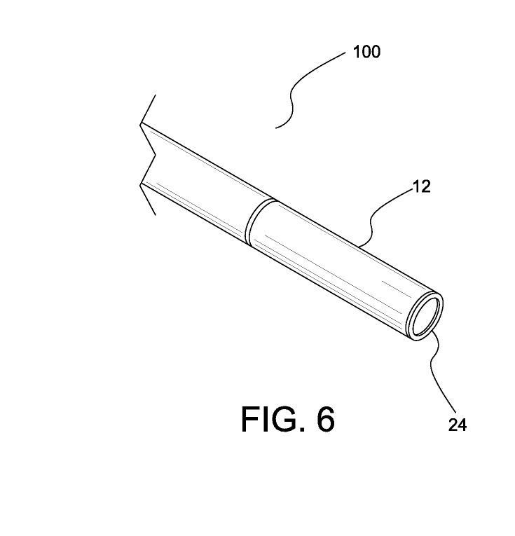

Other elements of a conventional cigarette, such as a filter or facsimile thereof, can also be incorporated, such as filter 24 in FIG. 1. For example, a filter can be attached to the proximal end of the device by pressure fit within a flange or an extended tube. The filter can be made of any suitable material, such as conventional cigarette filter material or another material that approximates the look and feel of such conventional material. FIG. 6 illustrates a more detailed view of exemplary filter 24. The use of a filter creates a more aesthetically pleasing mouthpiece both visually and tactilely to the tongue, as well as acting as a filter to reduce emissions of unwanted particles and the like.

Although the embodiments disclosed herein show the vapor delivery device as an electronic cigarette, the vapor delivery device is not limited to such a purpose or shape. The vapor delivery device can be an electronic cigar or other “smoking” device, an anesthetic vaporizer, a nebulizer, or any other vaporization device which heats a fluid with a heating element to produce a vapor.

The device can also take on any shape or form factor and is not limited to the physical dimensions disclosed herein. For example, if the vapor delivery device is used as a medical device, it can be constructed to resemble an inhaler or other medical device that a user is accustomed to. Many variations are possible.

While a vapor delivery device is described herein by way of example and embodiments, those skilled in the art recognize that the invention is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A vapor delivery device comprising:
a housing;
a liquid tank disposed within the housing, the liquid tank being adapted to hold a fluid;
a heating element disposed within the housing, the heating element being operable to vaporize at least a portion of the fluid;
a power source disposed with the housing and electronically coupled to the power source, and the heating element;
an electronics portion adapted to control heating element and the power source, wherein the electronics portion is configured to control charging of the vapor delivery device and harvesting of the charge to thereby cause the heating element to vaporize at least a portion of the fluid, wherein charging the vapor delivery device comprises periodically extracting and storing energy from the power source in a magnetic field, and wherein harvesting the charge comprises dumping the energy into a capacitor in the form of a charge and applying the aggregate charge to the heating element; and
an outlet extending from the liquid tank to an opening in the housing.

2. The vapor delivery device of claim 1, further comprising a filter.

3. The vapor delivery device of claim 1, wherein the electronic portion comprises a logic processor, one or more power electronics, and one or more sensors.

4. The vapor delivery device of claim 1, wherein the fluid includes nicotine.

5. The vapor delivery device of claim 1, further comprising a lighting portion disposed within the housing.

6. The vapor delivery device of claim 1, wherein the heating element is at least partially made of a nichrome alloy.

7. The vapor delivery device of claim 1, wherein the power source is an Alkaline battery.

8. The vapor delivery device of claim 1, wherein the power source is a lithium iron phosphate (LiFePo₄) battery.

9. The vapor delivery device of claim 1, wherein the electronics portion is further configured to utilize a bootstrap power arrangement.

10. A method for controlling the vaporization of a fluid by a vapor delivery device, the vapor delivery device comprising a housing, a liquid tank disposed within the housing and adapted to hold a fluid, a heating element disposed within the housing and operable to vaporize at least a portion of the fluid, a power source disposed with the housing and electronically coupled to the power source and the heating element, an electronics portion adapted to control heating element and the power source, and an outlet extending from the liquid tank to an opening in the housing, the method comprising:
controlling, by the electronics portion, charging of the vapor delivery device by periodically extracting and storing energy from the power source in a magnetic field; and
harvesting, by the electronics portion, the charge by dumping the energy into a capacitor in the form of a charge and applying the aggregate charge to the heating element to thereby cause the heating element to vaporize at least a portion of the fluid.

11. The method of claim 10, wherein the vapor delivery device further comprises a filter.

12. The method of claim 10, wherein the electronic portion comprises a logic processor, one or more power electronics, and one or more sensors.

13. The method of claim 10, wherein the fluid includes nicotine.

14. The method of claim 10, wherein the vapor delivery device further comprises a lighting portion disposed within the housing.

15. The method of claim 10, wherein the heating element is at least partially made of a nichrome alloy.

16. The method of claim 10, wherein the power source is an Alkaline battery.

17. The method of claim 10, wherein the power source is a lithium iron phosphate (LiFePo₄) battery.

18. The method of claim 10, further comprising utilizing a bootstrap power arrangement.
